(19) United States
(12) Patent Application Publication
(10) Pub. No.: US 2025/0068373 A1
(43) Pub. Date: Feb. 27, 2025

(54) METHOD, APPARATUS, AND COMPUTER-READABLE MEDIUM FOR RECONFIGURING AN ACTIVE REGION OF A DISPLAY

(71) Applicant: Intel Corporation, Santa Clara, CA (US)

(72) Inventors: Aruni NELSON, Folsom, CA (US); Ashok MISHRA, Portland, OR (US); Rajesh POORNACHANDRAN, Portland, OR (US)

(21) Appl. No.: 18/806,634

(22) Filed: Aug. 15, 2024

(51) Int. Cl. G06F 3/14; G06F 21/10; G09G 3/20

(52) U.S. Cl. CPC G06F 3/1446; G06F 21/1015; G09G 3/2096; G09G 2340/02; G09G 2340/0407; G09G 2354/00; G09G 2360/18

(57) ABSTRACT

A method, apparatus, and non-transitory computer-readable medium or reconfiguring an original active region of a first display is disclosed. The apparatus comprises interface circuitry for communication with both the first and second displays, memory circuitry, machine-readable instructions, and processor circuitry configured to execute the machine-readable instructions. The processor circuitry is operable to determine a subset active region within the original active region of the first display and to generate a hint for configuring the second display based on this subset active region.

### BACKGROUND

Existing display sub-systems and emerging technologies like foldable and flexible rollable displays have fixed active regions for rendering images. This active region displays images with automatic aspect-ratio scaling according to the operating system's (OS's) policy. Current display technologies face significant challenges, such as the inability to dynamically update and modify the physical active region of the display panel. Similarly, for Digital Rights Management (DRM) and Enterprise Rights Management (ERM) content, all data for the full active region is encrypted, leading to unnecessary power consumption. Additionally, any mode change in the display causes flicker due to synchronization issues.

Seamlessly updating an active region would be beneficial for several reasons, including the potential to save power when the full active region is not required for displaying an image and accommodating user preferences for scaling the active region. Moreover, encrypting and decrypting smaller data sets based on a dynamically reduced active region could result in significant power savings in computing, rendering (GPU), and display operations. Therefore, there is a demand to overcome the above challenges and dynamically adjust the active display region.

### BRIEF DESCRIPTION OF THE FIGURES

Some examples of apparatuses and/or methods will be described in the following by way of example only, and with reference to the accompanying figures, in which:

FIG. 1 shows a block diagram of an example of an apparatus for reconfiguring an active region of a display;

FIG. 2 illustrates an example of a first apparatus and a second apparatus each with respective display panels;

FIG. 3 shows a flowchart of a method determining a subset active region of an original active region;

FIG. 4 shows a flowchart for configuring display settings based on user preferences;

FIG. 5 shows a flowchart of actions in an example implementation with the touch subsystem and display subsystem when a user selects a new active display region;

FIG. 6 shows a flowchart to enable a reduced active region for display based on a user-selected new active region of display;

FIG. 7 illustrates an example system architecture of an embodiment in an Android-based system; and

FIG. 8 illustrates a computing device for reconfiguring an active region of a display.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

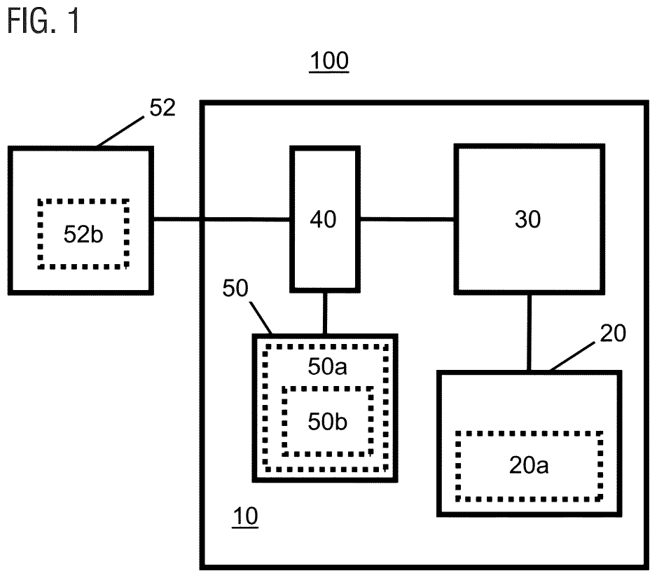

FIG. 1 shows a block diagram 100 of an example of an apparatus 10 or device 10 for reconfiguring an original active region 50a of a first display 50. The apparatus 10 comprises interface circuitry 40 to communicate with the first display 50 and a second display 52, memory circuitry 20, machine-readable instructions 20a, and processor circuitry 30 to execute the machine-readable instructions. The apparatus 10 determines a subset active region 50b of the original active region 50a and generates a hint to configure the second display 52 for the subset active region 50b. The second display 52 may display the subset active region 50b as an active region 52b of the second display 52.

The apparatus may allow for dynamic reconfiguration of the display area, optimizing the use of display resources and potentially saving power or computations by limiting the active display area. The apparatus 10 may also include several components designed to enhance the configuration and management of display settings, providing users with greater control and flexibility.

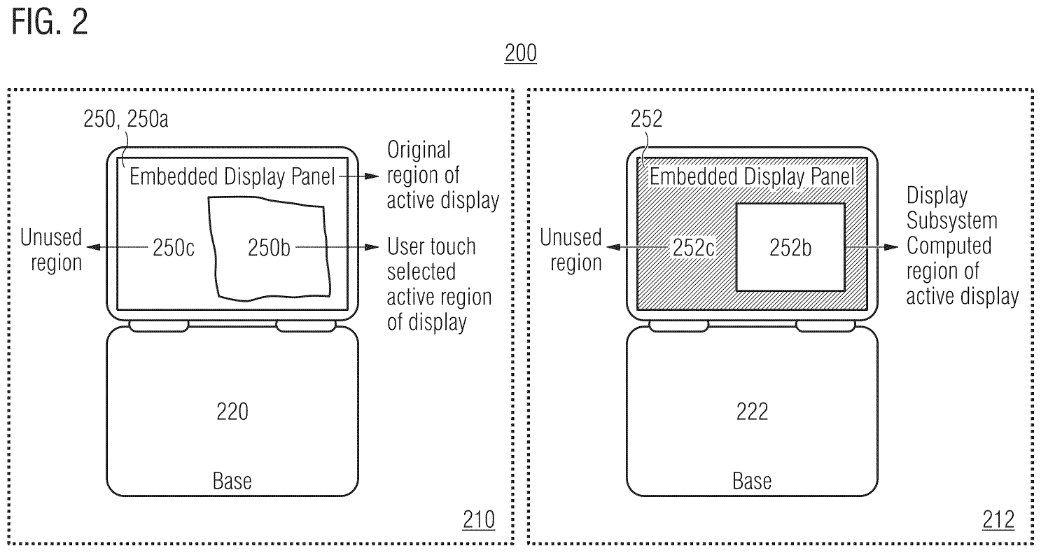

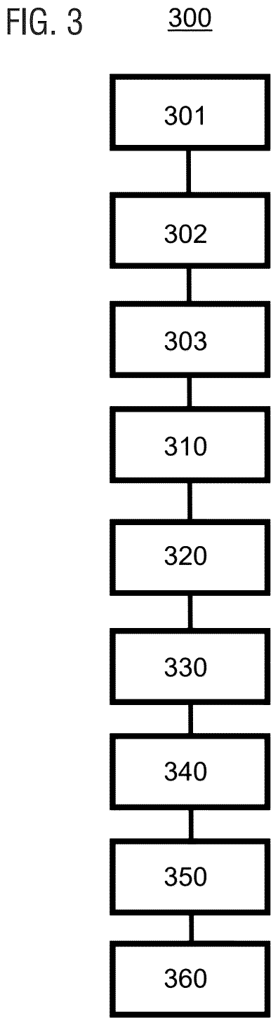

FIG. 1 further shows that the apparatus 10 comprises circuitry to provide the functionality of the apparatus 10. For example, the circuitry of the apparatus 10 may be configured to provide the functionality of the apparatus 10. For example, the apparatus 10 of FIG. 1 includes optional interface circuitry 40, processor circuitry 30, and memory circuitry 20. For example, the processor circuitry 30 may be coupled with the interface circuitry 40 and the memory circuitry 20. For example, the processor circuitry 30 may provide the functionality of the apparatus, in conjunction with the interface circuitry 40 (for exchanging information, such as with other components inside or outside the computer system 100 comprising the apparatus 10 or device 10), the memory circuitry 20 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 of FIG. 1 includes means for processing 30, which may correspond to or be implemented by the processor circuitry 30, means for communicating 40, which may correspond to or be implemented by the interface circuitry 40, (optional) means for storing information 20, which may correspond to or be implemented by the memory circuitry 20. In general, the functionality of the processor circuitry 30 or means for processing 30 may be implemented by the processor circuitry 30 or means for processing 30 executing machine-readable instructions. Accordingly, any feature ascribed to the processor circuitry 30 or means for processing 30 may be defined by one or more instructions of a plurality of machine-readable instructions. The apparatus 10 or device 10 may comprise the machine-readable instructions, e.g. within the memory circuitry 20, a storage circuitry (not shown), or a means for storing information 20. For example, the processor circuitry 30 or means for processing 30 may perform a method shown in the present disclosure, such as the method discussed in connection with FIG. 3. The apparatus may also be implemented in software, and components of the software may offer a range of functionalities. One component may be a configuration user interface (UI), depicted in FIG. 2.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 40 may comprise circuitry configured to receive and/or transmit information.

For example, the processor circuitry 30 or means for processing 30 may be implemented using one or more processing units, one or more processing devices, or any means for processing, such as a processor, a computer, or a programmable hardware component being operable with accordingly adapted software. In other words, the described function of the processor circuitry 30 or means for processing may as well be implemented in software, which is then executed on one or more programmable hardware components. Such hardware components may comprise a general-purpose processor, a Digital Signal Processor (DSP), a microcontroller, etc.

For example, the memory circuitry 20 or means for storing information 20 may be a volatile memory, e.g. random access memory, such as dynamic random-access memory (DRAM) or static random-access memory (SRAM).

FIG. 2 illustrates an example of a first apparatus 210 and a second apparatus 212 each with respective display panels 250, 252. The apparatuses 210, 212 may optionally have bases 220, 222 that comprise the appropriate circuitry for the displays. However, the circuity may also be housed within the display, or as a separate apparatus connected to the displays through wired or wireless connections. Likewise, the apparatuses are connected either by wired or wireless display interconnect technologies. These may be any graphics technology that enables the connection of one or more display monitors to a computer via USB, Ethernet, or wireless interfaces. These technologies may facilitate the extension of display capabilities without requiring dedicated video output ports for each monitor, utilizing software drivers to manage display outputs and support various operating systems, thereby enhancing the flexibility and scalability of display configurations.

FIG. 2 illustrates an example usage of configuration UI, which may be a user-triggered “New Active Display Region” mode. A user may choose to select a physically different active region for displaying images on the display panel. This new active region may be selected so that only critical information can be viewed on the second display panel. This may be important when the second display panel has a smaller physical real estate than the first and a user would like to display only valuable information. In OLED-like displays, the pixels in the unused region 252c of the display panel can be turned off, reducing the power consumed by the display panel. Likewise, because of the smaller active region, a smaller size of display data may be transmitted on the interconnect to the display panel, reducing the data transmitted.

The apparatus and associated method may be extended to selecting a new physical active region of display by the OS based on a learning model that can deduce the active region of display based on the usage of display panel real estate for different images and information used by the user. For example, if, at a certain time of the day, the user only uses certain critical information that is rendered in a specific smaller physical region of the display panel, the OS policy can inform the display subsystem of a new active region where only critical information is displayed and turn off the remaining physical area of the display panel.

The displays 250, 252 in FIG. 2 may be embedded display panels. The display panel 250 renders an original region 250a of the active display. A user may then select a subset region 250b for display on the display panel 252 of the second apparatus 212. The selection may be done through various means and, in particular, through a touch interaction. The display subsystem of either the first apparatus 210 or the second apparatus 212 may then compute the region of active display 252b for rendering on the display panel 252 of the second apparatus 212.

As shown in FIG. 2, an unused portion of the original active region 250c of the first display panel 250 is not rendered in the second display panel 252. In other words, the only active region of the second display panel 252 is region 252b and region 252c is unused and inactive. As also seen in FIG. 2, the roughly rectangular user selection of subset region 250b may be recomputed into an actually rectangular selection for the active region 252b on the second display 252. However, transposing a rectangular active area from one display to another is only illustrative. In an alternative embodiment, a pixel-by-pixel user selection may be made on the first display 250 for rendering in an approximate or exact shape on the second display 252. This is possible in pixel-addressable displays and may be beneficial when the second display is not rectangular, such as on a circular watch face or a phone screen with a cut-out or irregular shape.

The apparatus and the method it employs may result in display subsystem power reduction (i.e. in the second apparatus 212 or the overall system 200) is achieved when only a reduced portion of the display panel is used as the active region, leading to improved user experience by allowing the user to choose the active region. Additionally, there is a reduction in display interconnect usage as the data transmitted for the reduced active region decreases. In pixel-addressable displays with higher granularity control of the backlight, the backlight may be limited to the reduced active region, thereby reducing the power consumption of the display panel.

As shown in FIG. 2, the system 200 or apparatus 210, 212 may reduce power consumption of the display system by activating a reduced active display region initiated by the user. While several embodiments describe a user-initiated trigger to activate this reduced active region, it does not preclude automated system-triggered generation of a reduced active region based on the active usage of applications in certain regions of the display panel. For example, selecting a new physical active region of display may be done based on a learning model that can deduce the active region of display based on the usage of display panel by one or more users. Reduced active regions may also be selected based on ergonomic preferences, user-triggered or automated, to reduced active display regions when only critical information needs to be presented to the user and utilizing a small portion of a very high-resolution display (e.g. 8 k big screen TV) for PC productivity use cases.

An interface may allow users to configure and manage active region policies for various applications. By using this interface, users can easily set up and modify their display preferences and policies, tailoring the active regions of their displays to suit their needs better.

A hint may be generated to configure the second display for the subset active region. The hint may be a virtual hot plug event. A software hint may be a directive or suggestion given by software to guide or optimize the behavior of other software components, such as the operating system or hardware drivers, enhancing performance, efficiency, or functionality. A hot plug event (HPD) may refer to the physical act of connecting or disconnecting a display device (such as a monitor) to a computer system while it is powered on. This event prompts the display driver to detect the new hardware, reinitialize display settings, and update the display configuration accordingly. The HPD event is a signal used to inform the system of a change in the display configuration. A virtual HPE may be a software-triggered simulation of a hot plug event. This interaction hints the system to reconfigure the display's active region based on the user's selection, allowing for dynamic adjustments to the display area. It makes the display driver believe that a display device has been connected or disconnected, causing it to reinitialize display settings and update the configuration as if the physical connection change had occurred.

In some embodiments, the apparatus may interact with a graphics driver and window manager, such as Surface Flinger in Android systems. Surface Flinger is a component that composes window buffers into the display's frame buffer. The apparatus may generate a “New Virtual Hot Plug Detect (HPD) Event” after a user activates the “Change Active Display Region” mode and selects a new, reduced active region on the display panel.

In some embodiments, the apparatus may determine a resolution and/or a scale for the subset active region. Determining a scale for a subset of an active region may ensure optimal resolution and aspect ratio, resulting in better image quality and a more seamless user experience when extending or mirroring displays. A Dynamic Active Region Activator may do this within the display subsystem, specifically the display driver. This component is responsible for scaling the resolution of the frame to match the user-selected smaller active region. By dynamically adjusting the display settings, the activator may ensure that the content is appropriately rendered within the chosen area, enhancing the display's efficiency and user experience. The subset active region may generally be smaller (e.g. have a lower resolution or result in fewer pixels) than the original active region. Therefore, adapting the number of pixels or data that must be encrypted and decrypted based on the active display region may save computing resources or power compared to rendering the original active area. These benefits may also extend to thermal and reliability aspects since fewer pixels and data must be encrypted or displayed. Furthermore, settings around determining active areas may be policy configurable and enforced via platform Trusted Execution Environment (TEE).

In some embodiments, the apparatus may generate a plurality of frames for output to the second display based on the subset active region. As seen in FIG. 1, the apparatus 10 may further include a frame buffer associated with the original active display 50a of the first display 50, wherein rendering continues to occur from the original active display until the subset active region 50b, which appears as a second connected display 52, is configured to avoid flicker.

In some embodiments, the apparatus may queue the plurality of frames in a buffer of the second display. If another active region within the second display/subset active region is selected as a new display, a frame buffer may be required for the second display to continue rendering from it until the new active region/new display, indicated as a newly connected display, is configured.

Generating the plurality of frames may comprise rescaling a resolution of each frame based on the subset active region. Rescaling may refer to adjusting the resolution to match the dimensions of the subset active region. This feature may ensure that each frame is optimally resized to fit the subset active region, improving image clarity and display performance by preventing distortion and enhancing visual fidelity.

In some embodiments, the apparatus may compress the plurality of frames for output to the second display. Compressing may refer to reducing the frame data size using a compression algorithm to decrease the amount of data transmitted. This compression minimizes bandwidth usage and enhances data transmission efficiency to the second display, resulting in improved performance and reduced power consumption.

In certain scan-line-based display systems, implementing this disclosure may involve several steps. First, the display source generates smaller frames based on the active region the user selects, which is a specified portion of the display area designated for rendering. The display source may optionally compress these reduced frames using a Display Stream Compression (DSC) algorithm to decrease the data transmission load. Upon receiving the frames, the current scan-line-based display monitors decompress the frames, if compression has been applied, and render only the bands or scan lines that constitute the newly selected active region. Although this approach reduces power consumption by the display source and communication link due to the reduced data transmission, the power reduction at the display sink is limited by the need to process and render the bands or scan lines of the active region. This method optimizes data transmission and power consumption, enhancing the efficiency of current scan-line-based display systems.

The differences between prior implementations and the disclosed embodiments (existing vs. proposed UCARD features) can be summarized in Table 1.

TABLE 1

| | Prior Implementation | Disclosed Embodiments |
|---|---|---|
| Rollable, foldable | Static Active Region - based on | Dynamic Active Region |
| displays | the visible portion of a display | |
| External Display | Static Active Region | Dynamic Active Region |
| Embedded Display | Static Active Region | Dynamic Active Region |
| Content | DRM applied to the content | DRM is applied to the different |
| Management | displayed on the fixed/static | active regions of a display |
| | active region | |

In implementations based on the Video Electronics Standards Association's (VESA's) bulk display protocol, the display source generates smaller frames based on the active region selected by the user. This reduced frame data may be compressed using the most optimal compression algorithm available. If the display monitor is pixel-addressable, it will decompress the data. If compression has been applied, it will render it on the reduced set of pixels corresponding to the selected active region. In this scenario, both the display source and the display sink can minimize power consumption, including a decrease in the link power required for data transmission.

In some embodiments, the apparatus may receive a user selection of the original active region and determine the subset active region based on the user selection. User selection may refer to the input the user provides to designate a specific portion of the display. Examples of user selection include various input methods, such as clicking and dragging the mouse to select a rectangular area on the screen, using touchscreen gestures like pinching or swiping to define the active region and employing keyboard shortcuts to highlight or select specific portions of the display. Additionally, a user selection may be made through voice commands to specify the desired screen area, navigating through a software menu to choose a predefined active region, or utilizing a stylus to draw or mark the desired active area on a tablet or touchscreen device. These various input methods allow for dynamic and customizable adjustments to the active display area based on user preferences. This feature may allow the apparatus to dynamically adjust the active display area according to user preferences, enhancing customization and display management.

The user selection may be based on a touch interaction with the first display. A touch interaction may provide users with a more intuitive and efficient method to designate the active region. Touch interactions are natural and direct, allowing users to select areas of the screen quickly and accurately with simple gestures. Moreover, a direct touch interaction with the display may ensure that the selected active region accurately reflects the user's intentions, leading to a more intuitive and efficient selection process. This leads to enhanced user experience and productivity, as users can seamlessly interact with the display without the need for additional input devices like a mouse or keyboard. Additionally, touch interactions can reduce the complexity of user interfaces and make devices more accessible to a wider range of users, including those who may have difficulty using traditional input methods. User selection is not limited to touch interaction; it may also be made using a mouse pointer or other user interface where the user can enter the coordinates and size of the subset active region.

Additionally, the apparatus may introduce an interface between the display driver and the Human Interface Device (HID) driver, which manages input from devices such as touchscreens and mice. This interface communicates the user-selected active region to the display driver, ensuring that the specified area is used for display purposes. By sharing this information between the drivers, the system can accurately and efficiently adjust the display settings to reflect the user's preferences. FIG. 2 shows an example of this interface. These components collectively may provide a robust solution for managing and configuring display regions. They enable users to customize their display settings dynamically, improving their devices' overall functionality and responsiveness.

In some embodiments, the apparatus may check an access right to the content of the user selection and determine the subset active region based on the access right. This feature may ensure that only authorized content is displayed, enhancing security and compliance with digital rights management policies. For example, if a user selects a portion of a document that requires special permissions to view, the apparatus verifies the user's access rights. If the user has the necessary permissions, the selected area is displayed; otherwise, it remains inaccessible.

For any DRM (Digital Rights Management) and ERM (Enterprise Rights Management) content, the entire data needed for the full active region of the display is encrypted, resulting in unnecessary power consumption. Encrypting and decrypting smaller data (reduced pixel count) based on the changed active region of the display would lead to significant power savings in computing, rendering (GPU), and display. By restricting the encryption and decryption processes to the data corresponding to the active display region, the method achieves significant power savings in computing, rendering (GPU), and display operations. Furthermore, the apparatus 10 may configure and enforce policies via a platform Trusted Execution Environment (TEE) to manage the encryption and decryption processes. This policy-driven approach may ensure optimized resource usage while maintaining data security and processing reliability.

In some embodiments, the apparatus may request an access right from the content provider based on the user selection. This facilitates seamless access to restricted content by automatically initiating permission requests, thus reducing user intervention, and streamlining workflow. For instance, when a user selects a restricted video clip, the apparatus automatically requests access rights to the content provider. The video clip is displayed to the user upon receiving the necessary permissions. The apparatus may also check for previously saved and cached access rights and display content based on known rights.

In some embodiments, the apparatus can cache access rights to avoid repeated requests after the display is reconfigured. This caching mechanism may be policy configurable, allowing the system to control whether caching is permitted based on local or applied specific policies by a system administrator. The implementation specifics of caching may be tailored to meet the requirements of different applications, ensuring flexibility and adaptability. This approach reduces latency in accessing restricted content and enhances overall system efficiency by minimizing redundant access right requests.

Furthermore, the apparatus may include machine-readable instructions to determine one or more subset active regions of the original active region. This allows for more granular control and customization of display regions, enhancing the user's ability to manage multiple tasks and display configurations. For example, on a large display, the user can select and define multiple smaller areas for different applications, such as one area for a video call and another for document editing.

In some embodiments, the apparatus may generate one or more further hints to configure additional displays based on the subset active regions identified. This feature may improve multi-display management by providing automated configuration suggestions, ensuring optimal display settings, and reducing manual adjustments. For instance, after identifying multiple subset active regions, the apparatus suggests optimal settings for connecting and configuring additional monitors, such as resolution and orientation, based on the content and user preferences.

Displays, such as the first and second displays 50, 52, may be internal or external to the apparatus 10. In one embodiment, the first display 50 may be an embedded display. Current display technologies allow techniques such as partial updates and tiled displays to save power. However, the image/frame is rendered on the display panel's fixed (entire real estate) active region. Currently, foldable and rollable displays support only static active regions on the portion of the display determined at manufacturing time; they are static and not user-configurable and on-demand. A display may be any device or component capable of presenting visual information to a user, typically comprising a screen or interface on which data, images, or other visual elements can be rendered and perceived. This may include, but is not limited to, LCD (Liquid Crystal Display), LED (Light Emitting Diode) displays, OLED (Organic Light Emitting

Diode) displays, plasma screens, and other technologies that facilitate the visual representation of electronic information.

The disclosure apparatus and methods may provide software-driven seamless management of display active region physical real estate for improved user experience and platform power savings. This involves a “Virtual Hot Plug” based approach to adapt to new active regions, combined with software-managed queuing of frames in the display's PSR (Panel Self Refresh) buffer for a seamless transition between the original and subset areas on the second or external display. From a DRM and ERM aspect, only need-based pixels (based on the current active region) are computed, rendered, and encrypted, increasing power efficiency.

This application proposes the following novel components: UCARD app & framework: Software components introduced in this disclosure that provide the following functionality. First, a Configuration UI where users could configure and manage active region policies associated with apps. Second, interaction with the platform Graphics driver and Window manager (for example, Surface Flinger in Android) to hint the system to reconfigure display active region via virtual HPD event. “New Virtual Hot Plug Event” is generated after the user has activated the “Change Active Display Region” mode and chosen a new reduced active region on the display panel. Third, a new Logic/Dynamic Active Region Activator in the display subsystem (Display Driver), which, based on user input, scales the resolution of the frame to be displayed in a smaller active region chosen by the user. Fourth, a new interface between the Display Driver and HID Driver (e.g. touch or mouse) to share the chosen region on the display panel to be used as an active region for the display.

Platform policies may be configured through the system root of trust to allow/disallow changing of the active region of the display and the content to be displayed in the new active region. The apparatus and methods disclosed may be extended to any device, PCs, Handheld devices, or embedded or external display monitors. Additionally, there could be different mechanisms to trigger the event of placing a system in a mode that allows input from the user to select a new rectangular region for display (with AI PC intercept), such as “New voice-activated command/Change Active Display Region,” a user interface exposing the option to “Change Active Display Region,” etc.

FIG. 1 further shows system 100 comprising processor circuitry 30, and a non-transitory, machine-readable medium 20 storing program code 20a. The processor circuitry 30 may be coupled to the machine-readable medium 20 via a memory channel. The program code 20a, when executed by the processor circuitry 30, enables the system 100 to reconfigure an active region of a display. The system may be configured determine a subset active region 50b of the original active region 50a and generate a hint to configure the second display 52 for the subset active region 50b. The second display 52 may display the subset active region 50b as an active region 52b of the second display 52.

The computer system 100 may be at least one of a client computer system, a server computer system, a rack server, a desktop computer system, a mobile computer system, a security gateway, and a router. The mobile device 100 may be a smartphone, tablet, wearable, or mobile computer.

More details and aspects of the concept for determining a subset active region may be described in connection with examples discussed below (e.g. FIGS. 3 to 8).

FIG. 3 shows a flowchart of a method 300 for determining a subset active region of an original active region of the first display. The method may begin with step 310, which involves determining a subset active region of an original active region of the first display. In step 320, the method generates a hint to configure the second display for the subset active region. This hint may take the form of a virtual hot plug event.

The method may include determining a resolution and/or scale for the subset active region in step 330. The method may further entail generating a plurality of frames for output to the second display based on the subset active region in step 340. Generating the plurality of pt frames may include rescaling each frame's resolution based on the subset active region when generating these frames.

The method may further include queueing the plurality of frames in a buffer of the second display, as depicted in step 350, and compressing the plurality of frames for output to the second display, shown in step 360.

In a preliminary step 301, the method may involve receiving a user selection of the original active region to determine the subset active region based on the user selection. This selection process may be based on a touch interaction with the first display. The method may also include checking an access right to the content of the user selection and determining the subset active region based on this access right, as shown in step 302. If required, the method proceeds to step 303, where it requests access rights from a content provider based on user selection.

The method may determine one or more subset active regions of the original active region and generate one or more further hints to configure one or more displays for each subset active region. This method may enhance display management by dynamically adjusting settings based on user interactions and access rights, optimizing both functionality and efficiency.

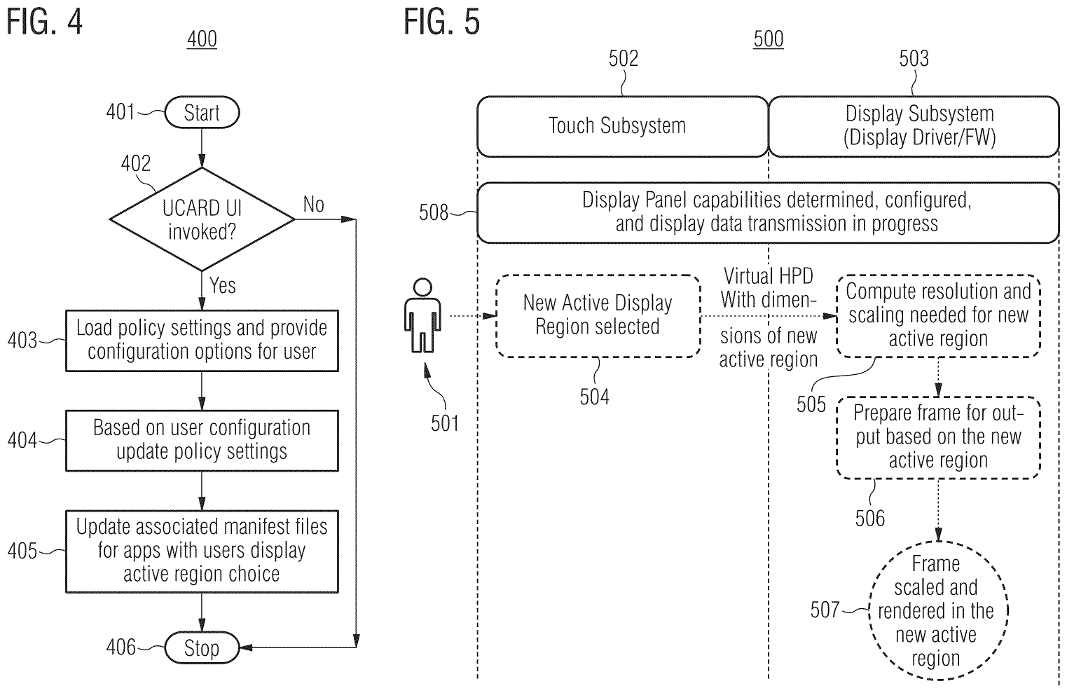

More details and aspects of the concept for determining a subset active region may be described in connection with examples discussed above (e.g. FIGS. 1 and 2) or below (e.g. FIGS. 4 to 8).

FIGS. 4 and 5 illustrate the high-level flow for embodiments where the user may choose to select the new active region of the display. FIG. 4 shows a flowchart 400 for configuring display settings based on user preferences. The method begins with the start step (401). At decision point (402), the system determines whether the User Configurable Active Region of Display (UCARD) user interface (UI) is invoked. If the UCARD UI is invoked (YES), the method proceeds to step (403), where the system loads the policy settings and provides configuration options for the user. In step (404), the policy settings are updated based on the user configuration. In step (405), the system updates the associated manifest files for applications to incorporate the user's selected display active region. The method concludes with the stop step (406), which is also reached if the UCARD UI is not invoked (NO). This configuration flow enables dynamic adjustment of display settings, ensuring that user preferences are accurately reflected in the system's operational parameters.

FIG. 5 shows a flowchart 500 of actions in an example implementation with the touch subsystem 502 and display subsystem 503 when a user 501 selects a new active display region. The touch subsystem 503 determines that a new active display region is selected (step 504) by the user 501. A virtual HPD with dimensions of the new active region is then sent to the display subsystem 503. The display subsystem then computes the resolution and scaling needed for the new active region (step 505), prepares frames for output based on the new active region (step 506), and then scales and renders the frame in the new active region (step 507).

The operation of determining the display panel capabilities, configuring, and transmitting the display data may be done based on the currently existing methods and standards (step 508). Prior to the user selecting the subset of the original active region, the display panel capabilities, configuration, and transmission of data to the first/original display may occur in the typical fashion. Once the original active area is set up, the user can go about selecting the subset active regions. In some embodiments, once the subset is determined, either by the system or by the user, the subset active region may be saved by the system. System policies or settings may then determine if the subset active region should be maintained until the user chooses to change it or if the next reboot always brings the original display active region of the display panel. For example, if a user connects a second display to the system, the system policies may be set to maintain the customized active region that the user has previously selected. However, if the user reboots the system, the display may either maintain this customized active region or revert to the original active region, depending on the predetermined system settings.

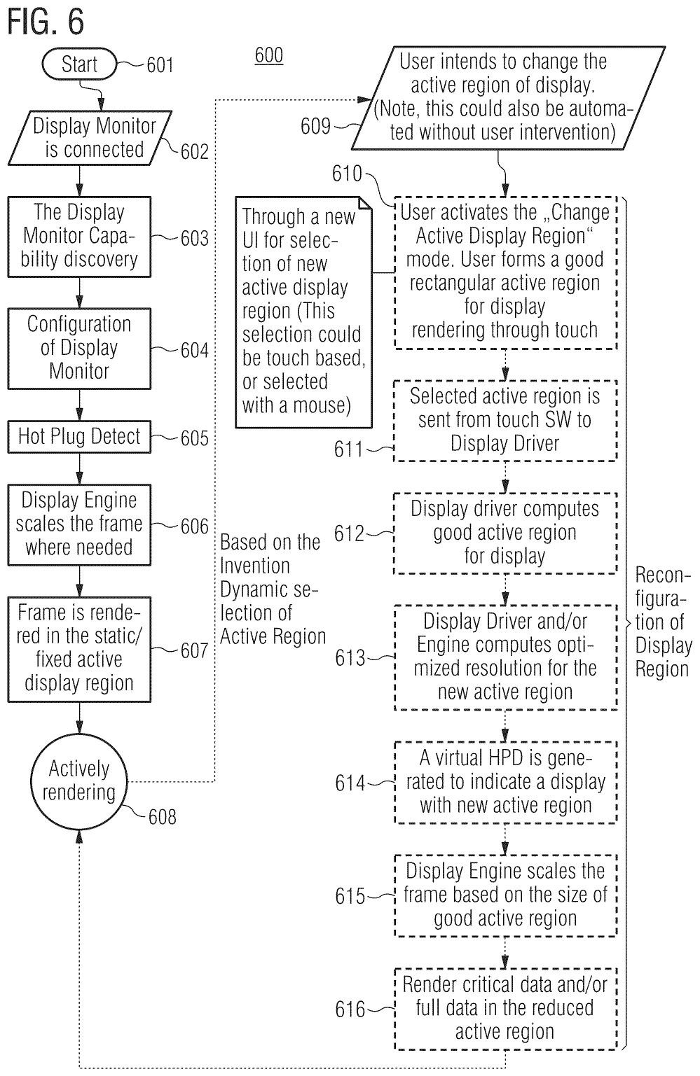

More details and aspects of the concept for determining a subset active region may be described in connection with examples discussed above (e.g. FIGS. 1 to 3) or below (e.g. FIGS. 6 to 8).

FIG. 6 shows a flowchart with an example implementation with the touch subsystem 502 and display subsystem 503 to enable reduced active region for display based on the user-selected new active region of the display. The method begins with the initiation of the process (step 601), where the system configures the display connection and rendering. This process continues (steps 602 to 608) until the user intends to select a subset active region (step 609), and then the system prepares to reconfigure the display based on user input (step 610).

The display monitor is connected (either externally connected or embedded, in which case the display monitor is always connected), establishing a communication link between the monitor and the system (step 602). The system then proceeds to discover the capabilities of the connected display monitor, such as its resolution, supported display modes, and other technical specifications (step 603).

Based on the discovered capabilities, the system configures the display monitor, setting the appropriate display parameters to ensure optimal performance (step 604). Subsequently, a hot plug event is detected, signaling the detection of a connected display monitor (step 605).

In response to the hot plug event, the display engine scales the frame as needed to fit the active region of the detected display monitor, ensuring that the content is properly adjusted for display (step 606). The system then renders the frame within the static active display region, preparing the content for viewing (step 607). Finally, the system actively renders the content in the configured display monitor with the static display region (step 608).

Branching off from step 608, the method includes additional steps pertaining to this disclosure to allow the detection and configuration of user-selected active display regions. A user intending to use a smaller portion of the display monitor (step 609) activates a “Change Active Display Region” mode and selects a rectangular active region for display rendering through a touch-based user interface or mouse selection (step 610). This interaction allows the user to define the specific area of the display they wish to utilize, optimizing the display space for their needs. The selected active region is then sent from the touch software to the display driver, enabling the system to process the user's input (step 611). The display driver computes the optimal active region for the display, taking into account the dimensions and position of the user-selected area (step 612). Along with the display engine, the display driver determines the optimized resolution for the new active region, ensuring the content is displayed clearly and efficiently within the specified area (step 613).

A virtual Hot Plug Detect (HPD) event is generated to indicate the detection of a new display configured to the new active region, effectively updating the system to recognize the new display parameters (step 614). The display driver then scales the frame based on the size of the new active region, adjusting the content to fit the newly defined display space (step 615). Finally, the system renders critical data and/or the full data within this reduced active region, ensuring that essential information is displayed prominently while optimizing the use of the display area (step 616). The process returns to step 608, actively rendering the content in the newly configured active display region, continuously updating, and adapting to user interactions and preferences.

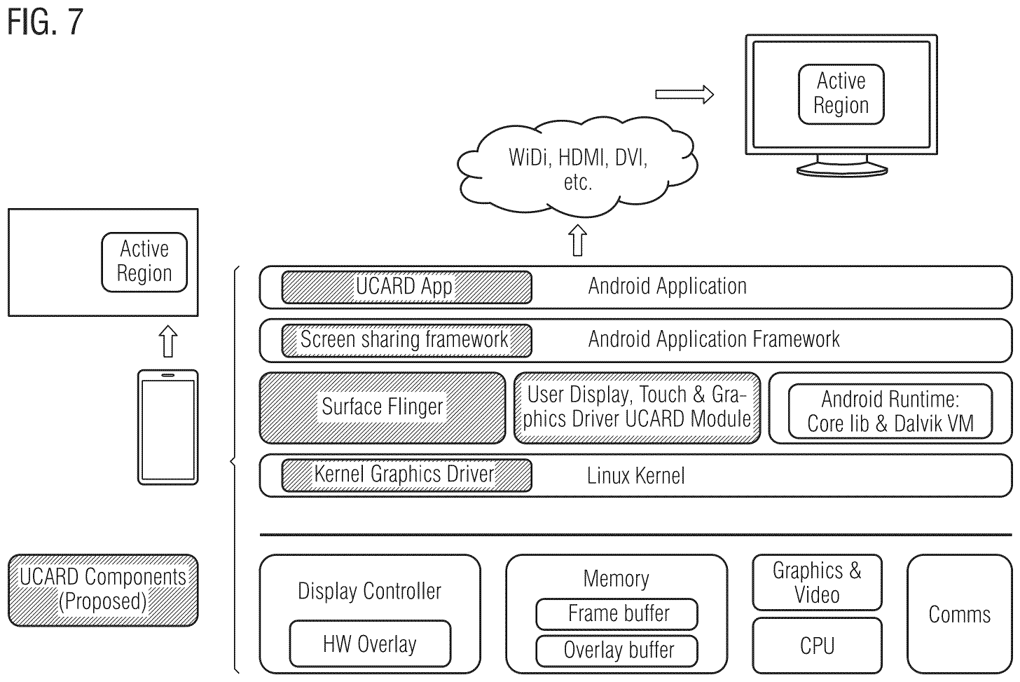

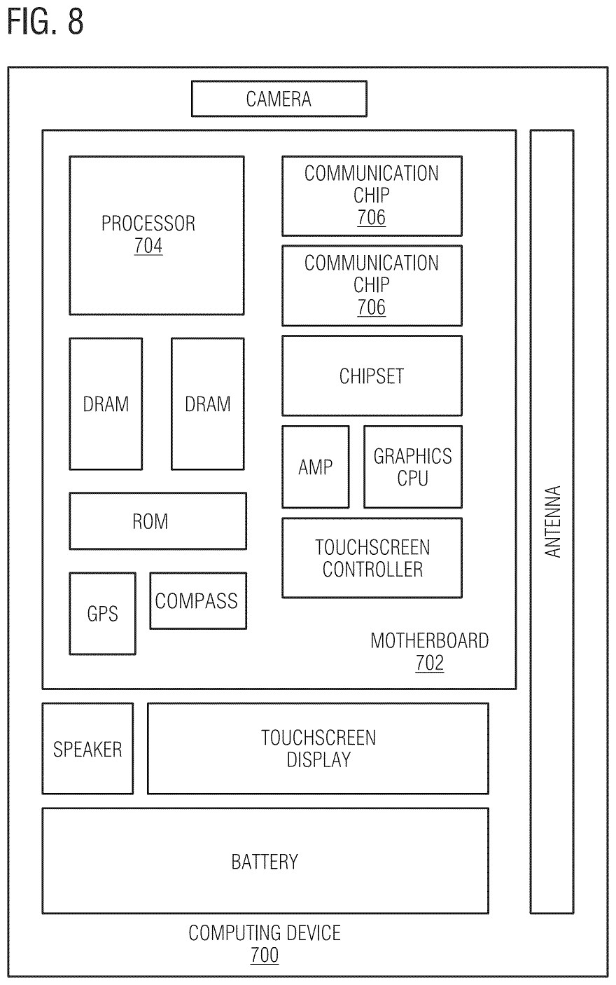

More details and aspects of the concept for determining a subset active region may be described in connection with examples discussed above (e.g. FIGS. 1 to 5) or below (e.g. FIGS. 7 and 8).

FIG. 7 illustrates an example system architecture of an embodiment in an Android-based system. The figure indicates the components that may require new logic as described above. Similar system architecture may be applied to Windows and systems with other OS. The system has an Android Application, an Android Application Framework, a Linux Kernal, Display Controller, Memory, Graphics & Video, CPU, and Communication components. The system 700 shows how an active region of the smartphone display may be retransmitted to an active region of an exterior display over WiDi, HDMI, DVI, or other display links.

A non-transitory, computer-readable medium comprising a program code that, when the program code is executed on a processor, a computer, or a programmable hardware component, causes the processor, computer, or programmable hardware component to perform any of the methods discussed herein.

More details and aspects of the concept for offloading a workload may be described in connection with examples discussed above (e.g. FIGS. 1 to 7) or below (e.g. FIG. 8).

FIG. 8 illustrates a computing device 700 per one implementation of the invention. The computing device 700 houses a board 702. The board 702 may include several components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g. DRAM), non-volatile memory (such as, ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as, hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev—DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev—DO, and others.

The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

More details and aspects of the concept for adapting a processor to a workload may be described in connection with examples discussed above (e.g. FIGS. 1 to 2).

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g. example 1) relates to an apparatus comprising interface circuitry to communicate with a first display and a second display, memory circuitry, machine-readable instructions, and processor circuitry to execute the machine-readable instructions to: determine a subset active region of the original active region, and generate a hint to configure the second display for the subset active region.

Another example (e.g. example 2) relates to a previously described example (e.g. example 1), wherein the hint is a virtual hot plug event.

Another example (e.g. example 3) relates to a previously described example (e.g. one of examples 1 or 2), further comprising the machine-readable instructions to determine a resolution and/or a scale for the subset active region.

Another example (e.g. example 4) relates to a previously described example (e.g. example 3), wherein the resolution and/or the scale is smaller than the original active region.

Another example (e.g. example 5) relates to a previously described example (e.g. one of examples 1-4), further comprising the machine-readable instructions to generate a plurality of frames for output to the second display based on the subset active region.

Another example (e.g. example 6) relates to a previously described example (e.g. example 5), wherein generating the plurality of frames further comprises rescaling a resolution of each frame based on the subset active region.

Another example (e.g. example 7) relates to a previously described example (e.g. one of examples 5 or 6), further comprising the machine-readable instructions to queue the plurality of frames in a buffer of the second display.

Another example (e.g. example 8) relates to a previously described example (e.g. one of examples 5 or 6), further comprising the machine-readable instructions to compress the plurality of frames for output to the second display.

Another example (e.g. example 9) relates to a previously described example (e.g. one of examples 1-8), further comprising the machine-readable instructions to receive a user selection of the original active region and determine the subset active region based on the user selection.

Another example (e.g. example 10) relates to a previously described example (e.g. example 9), wherein the user selection is based on a touch interaction with the first display.

Another example (e.g. example 11) relates to a previously described example (e.g. one of examples 9 or 10), further comprising the machine-readable instructions to check an access right to a content of the user selection and determine the subset active region based on the access right.

Another example (e.g. example 12) relates to a previously described example (e.g. one of examples 9 or 10), further comprising the machine-readable instructions to request an access right from a provider of the content of the user selection based on the user selection.

Another example (e.g. example 13) relates to a previously described example (e.g. one of examples 1-12), further comprising the machine-readable instructions to: determine one or more subset active regions of the original active region, and generate one or more further hints to configure one or more further displays for each of the one or more subset active regions.

An example (e.g. example 14) relates to a method comprising: determining a subset active region of an original active region of the first display, and generating a hint to configure the second display for the subset active region.

Another example (e.g. example 15) relates to a previously described example (e.g. example 14), wherein the hint is a virtual hot plug event.

Another example (e.g. example 16) relates to a previously described example (e.g. one of examples 14 or 15), further comprising determining a resolution and/or a scale for the subset active region.

Another example (e.g. example 17) relates to a previously described example (e.g. example 16), wherein the resolution and/or the scale is smaller than the original active region.

Another example (e.g. example 18) relates to a previously described example (e.g. one of examples 14-17), further comprising generating a plurality of frames for output to the second display based on the subset active region.

Another example (e.g. example 19) relates to a previously described example (e.g. example 18), wherein generating the plurality of frames further comprises rescaling a resolution of each frame based on the subset active region.

Another example (e.g. example 20) relates to a previously described example (e.g. one of examples 18 or 19), further comprising queueing the plurality of frames in a buffer of the second display.

Another example (e.g. example 21) relates to a previously described example (e.g. one of examples 18 or 19), further comprising compressing the plurality of frames for output to the second display.

Another example (e.g. example 22) relates to a previously described example (e.g. one of examples 14-21), further comprising receiving a user selection of the original active region and determining the subset active region based on the user selection.

Another example (e.g. example 23) relates to a previously described example (e.g. example 22), wherein the user selection is based on a touch interaction with the first display.

Another example (e.g. example 24) relates to a previously described example (e.g. one of examples 22 or 23), further comprising checking an access right to a content of the user selection and determining the subset active region based on the access right.

Another example (e.g. example 25) relates to a previously described example (e.g. one of examples 22 or 23), further comprising requesting an access right from a provider of the content of the user selection based on the user selection.

Another example (e.g. example 26) relates to a previously described example (e.g. one of examples 14-25), further comprising: determining one or more subset active regions of the original active region, and generating one or more further hints to configure one or more further displays for each of the one or more subset active regions.

An example (e.g. example 27) relates to system comprising an apparatus according to a previously described example (e.g. one of examples 1-13) and/or implementing a method according to a previously described example (e.g. one of examples 14-26).

An example (e.g. example 28) relates to a non-transitory, computer-readable medium comprising a program code that, when the program code is executed on a processor, a computer, or a programmable hardware component, causes the processor, computer, or programmable hardware component to perform the method of a previously described example (e.g. examples 14-26).)

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor-or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus for reconfiguring an original active region of a first display, the apparatus comprising interface circuitry to communicate with the first display and a second display, memory circuitry, machine-readable instructions, and processor circuitry to execute the machine-readable instructions to:
determine a subset active region of the original active region, and generate a hint to configure the second display for the subset active region.

2. The apparatus of claim 1, wherein the hint is a virtual hot plug event.

3. The apparatus of claim 1, further comprising the machine-readable instructions to determine a resolution and/or a scale for the subset active region.

4. The apparatus of claim 1, further comprising the machine-readable instructions to generate a plurality of frames for output to the second display based on the subset active region.

5. The apparatus of claim 4, wherein generating the plurality of frames further comprises rescaling a resolution of each frame based on the subset active region.

6. The apparatus of claim 4, further comprising the machine-readable instructions to:
queue the plurality of frames in a buffer of the second display.

7. The apparatus of claim 4, further comprising the machine-readable instructions to:
compress the plurality of frames for output to the second display.

8. The apparatus of claim 1, further comprising the machine-readable instructions to receive a user selection of the original active region and determine the subset active region based on the user selection.

9. The apparatus of claim 8, wherein the user selection is based on a touch interaction with the first display.

10. The apparatus of claim 8, further comprising the machine-readable instructions to check an access right to a content of the user selection and determine the subset active region based on the access right.

11. The apparatus of claim 8, further comprising the machine-readable instructions to request an access right from a provider of the content of the user selection based on the user selection.

12. A method for reconfiguring an original active region of a first display, the method comprising:
determining a subset active region of an original active region of the first display, and
generating a hint to configure the second display for the subset active region.

13. The method of claim 12, further comprising determining a resolution and/or a scale for the subset active region.

14. The method of claim 12, further comprising generating a plurality of frames for output to the second display based on the subset active region, wherein generating the plurality of frames further comprises rescaling a resolution of each frame based on the subset active region.

15. The method of claim 14, further comprising queueing the plurality of frames in a buffer of the second display.

16. The method of claim 14, further comprising compressing the plurality of frames for output to the second display.

17. The method of claim 12, further comprising receiving a user selection of the original active region and determining the subset active region based on the user selection.

18. The method of claim 17, further comprising checking an access right to a content of the user selection and determine the subset active region based on the access right.

19. The method of claim 17, further comprising requesting an access right from a provider of the content of the user selection based on the user selection.

20. A non-transitory, computer-readable medium comprising a program code that, when the program code is executed on a processor, a computer, or a programmable hardware component, causes the processor, computer, or programmable hardware component to perform the method of claim 12.
